(19) United States
(12) Patent Application Publication
(10) Pub. No.: US 2019/0180670 A1
(43) Pub. Date: Jun. 13, 2019

(54) LIQUID CRYSTAL DRIVING APPARATUS AND LIQUID CRYSTAL DISPLAY APPARATUS

(71) Applicant: CANON KABUSHIKI KAISHA, Tokyo (JP)

(72) Inventor: Masayuki Abe, Tokyo (JP)

(21) Appl. No.: 16/205,503

(22) Filed: Nov. 30, 2018

(30) Foreign Application Priority Data
Dec. 7, 2017 (JP) 2017-234798

(51) Int. Cl. G09G 3/20; G09G 3/36

(52) U.S. Cl. CPC G09G 3/2081; G09G 2320/064; G09G 2320/0633; G09G 3/36

(57) ABSTRACT

A liquid crystal driving apparatus configured to drive a liquid crystal element which illumination light from a light source enters includes an image data generator configured to generate display image data from each of input frame image data that is input consecutively, a driver configured to enable each pixel to display a gradation by controlling, based on the display image data, an application of a first voltage to each pixel in the liquid crystal element in each of a plurality of subframe periods contained in one frame period and an application of a second voltage lower than the first voltage, and a controller configured to control an intensity of the illumination light.

### BACKGROUND OF THE INVENTION

### Field of the Invention

The present invention relates to a liquid crystal driving apparatus that displays a gradation by driving a liquid crystal element in a pulse width modulation (PWM) manner.

### Description of the Related Art

As a liquid crystal element, there are a transmission type liquid crystal element, such as a twisted nematic (TN) element, and a reflection type liquid crystal element, such as a vertical alignment nematic (VAN) element. A driving method of these liquid crystal element contains an analogue driving method for controlling the brightness by changing the voltage applied to a liquid crystal layer in accordance with the gradation, and a digital driving method for binarizing the voltage applied to the liquid crystal layer and for controlling the brightness by changing the voltage application period. One type of the digital driving method, which is referred to as a subframe (or subfield) driving method, is a subframe driving method that divides one frame period into a plurality of subframe periods on a time axis, controls the application (turning on) and nonapplication (turning off) of the predetermined voltage to the pixel for each subframe, and displays the gradation on the pixels.

Next follows a description of the general subframe driving method. FIG. 19 illustrates an example that divides one frame period into a plurality of subframe periods (bit lengths). A numerical value on each subframe represents a time weight on the subframe in one frame period. In an example, 64 gradations are expressed. In this description, a period of the time weight of 1+2+4+8+16 will be referred to as an A subframe period, and a period of the time weight of 32 will be referred to as a B subframe period. Moreover, a subframe period in which the above predetermined voltage is turned on will be referred to as an ON period, and a subframe period in which the above predetermined voltage is turned off will be referred to as an OFF period.

FIG. 20 illustrates all-gradation data corresponding to the subframe division examples illustrated in FIG. 19. The ordinate axis represents a gradation, and the abscissa axis represents one frame period. In the figure, a white subframe period represents the ON period for displaying the pixel in white, and a black subframe period represents the OFF period for displaying the pixel in black. According to this gradation data, in displaying two continuous gradations, such as a thirty-second gradation and a thirty-third gradation, on two adjacent pixels in the liquid crystal element, the A subframe period is set to the ON period for the thirty-second gradation and set to the OFF period for the thirty-third gradation. In addition, the B subframe period is set to the OFF period for the thirty-second gradation and set to the ON period for the thirty-third gradation.

When the ON period and the OFF period are thus concurrent with each other between two adjacent pixels or when a predetermined voltage is applied to one of the adjacent pixels and is not applied to the other of the adjacent pixels at the same time, a so-called disclination occurs and the brightness lowers in the ON pixel.

FIG. 21 illustrates an image with reduced brightness due to the disclination. The vertical direction indicates the gradation, and the concentration indicates the display brightness. When there is no disclination, the smooth concentration is expressed, but in the adjacent gradations (the thirty-second gradation and the thirty-third gradation herein) in which the ON period and the OFF period overlap each other for a long time in adjacent pixels, the influence of the disclination lowers the brightness and the dark lines appear.

Japanese Patent Laid-Open No. (“JP”) 2013-050681 discloses a driving circuit that divides a long subframe period into a plurality of subframe periods equal to other short subframe periods. When the phases of the bits in the gradation data corresponding to the adjacent pixels are different from each other, the driving circuit in JP 2013-050681 maintains the gradation and makes a correction so as to make closer the bit arrangement of the gradation data corresponding to one pixel to the bit arrangement of the gradation data corresponding to the other pixel. Thereby, the subframe period (referred to as “ON/OFF adjacent period” hereinafter) in which the ON period and the OFF period overlap each other in the adjacent pixels can be made shorter than that where the long subframe period is not divided.

However, the method disclosed in JP 2013-050681 is significantly influenced by the brightness dropped caused by the disclination, since the shortest time of the ON/OFF adjacent period in the adjacent pixels is long. The long ON/OFF adjacent period in the adjacent pixels increases a brightness dropped amount caused by the disclination according to the response speed of the liquid crystal molecules.

FIG. 22 illustrates the gradation data for displaying all 96 gradations disclosed in JP 2013-050681. The A subframe period corresponds to the time weight 1+2+4+8, and the B subframe period is divided into a plurality of divided subframe periods 1SF (“SF” stands for the subframe) to 10SF each corresponding to the time weight 8. One divided subframe period is 0.69 ms. In this gradation data, the shortest time of the ON/OFF adjacent period in the adjacent pixels is 1.39 ms corresponding to two divided subframe periods. Hence, the dropped brightness caused by the disclination (or a dark line) is conspicuous.

### SUMMARY OF THE INVENTION

The present invention provides a liquid crystal driving apparatus, an image display apparatus using the same, and the like, which can reduce the image degradation, such as conspicuous dark lines, caused by the disclination.

A liquid crystal driving apparatus according to one aspect of the present invention configured to drive a liquid crystal element which illumination light from a light source enters includes an image data generator configured to generate display image data from each of input frame image data that is input consecutively, a driver configured to enable each pixel to display a gradation by controlling, based on the display image data, an application of a first voltage to each pixel in the liquid crystal element in each of a plurality of subframe periods contained in one frame period and an application of a second voltage lower than the first voltage, and a controller configured to control an intensity of the illumination light. The image data generator multiplies the input frame image data that is different from or equal to each other by a first gain and a second gain lower than the first gain, generates first display image data and second display image data, inserts black insertion image data between the first display image data and the second display image data and after the second display image data, and sequentially outputs the first display image data, the black insertion image data, the second display image data, and the black insertion image data as the display image data to the driver. The black insertion image data is generated by multiplying the input frame image data by a third gain lower than the second gain. The controller makes lower the intensity of the illumination light when the liquid crystal element is driven based on the first display image data than that when the liquid crystal element is driven based on the second display image data.

Further features of the present invention will become apparent from the following description of exemplary embodiments with reference to the attached drawings.

### BRIEF DESCRIPTION OF THE DRAWINGS

FIGS. 1A and 1B illustrate an optical configuration of a liquid crystal projector according to an embodiment of the present invention.

FIG. 2 is a sectional view of a liquid crystal element used in the projector according to the embodiment.

FIG. 3 illustrates a plurality of subframe periods in one frame period according to the embodiment.

FIG. 4 illustrates gradation data in an A subframe period according to the embodiment.

FIG. 5 illustrates all-gradation data according to the embodiment.

FIG. 6 illustrates pixel lines according to the embodiment.

FIG. 7 is a graph illustrating a liquid crystal response characteristic when an all-white display is switched to a monochrome display according to the embodiment.

FIG. 8 illustrates a brightness response characteristic when the all-white display is switched to the monochrome display according to the embodiment.

FIG. 9 is a graph illustrating a liquid crystal response characteristic when an all-black display is switched to the monochrome display according to the embodiment.

FIG. 10 illustrates a brightness response characteristic when the all-black display is switched to the monochrome display according to the embodiment

FIG. 11 is a block diagram illustrating a configuration of the liquid crystal driver according to the embodiment.

FIGS. 12A and 12B illustrate bright output, black insertion, and dark output frame image data according to the embodiment.

FIGS. 13A to 13C illustrate a bright display image, a black insertion image, and a dark output image according to the embodiment.

FIGS. 14A to 14C are other views illustrating the bright display image, the black insertion image, and the dark output image according to the embodiment.

FIG. 15 is yet another view illustrating the bright display image, the black insertion image, and the dark output image according to the embodiment.

FIGS. 16A and 16B explain the liquid crystal element driven by the line-sequential driving method according to the embodiment.

FIG. 17 illustrates a brightness change in the light source according to the embodiment.

FIGS. 18A and 18B illustrate combined brightness between the brightness of the liquid crystal element and the brightness of the light source according to the embodiment.

FIG. 19 illustrates a plurality of subframe periods in one frame period according to prior art.

FIG. 20 illustrates conventional all-gradation data.

FIG. 21 illustrates the disclination where the liquid crystal element is driven according to the gradation data in FIGS. 13A to 13C.

FIG. 22 illustrates the all-gradation data in JP 2013-050681.

FIG. 23 is a flowchart illustrating a light source control according to the embodiment.

### DESCRIPTION OF THE EMBODIMENTS

Referring now to the accompanying drawings, a description will be given of embodiments according to the present invention.

### First Embodiment

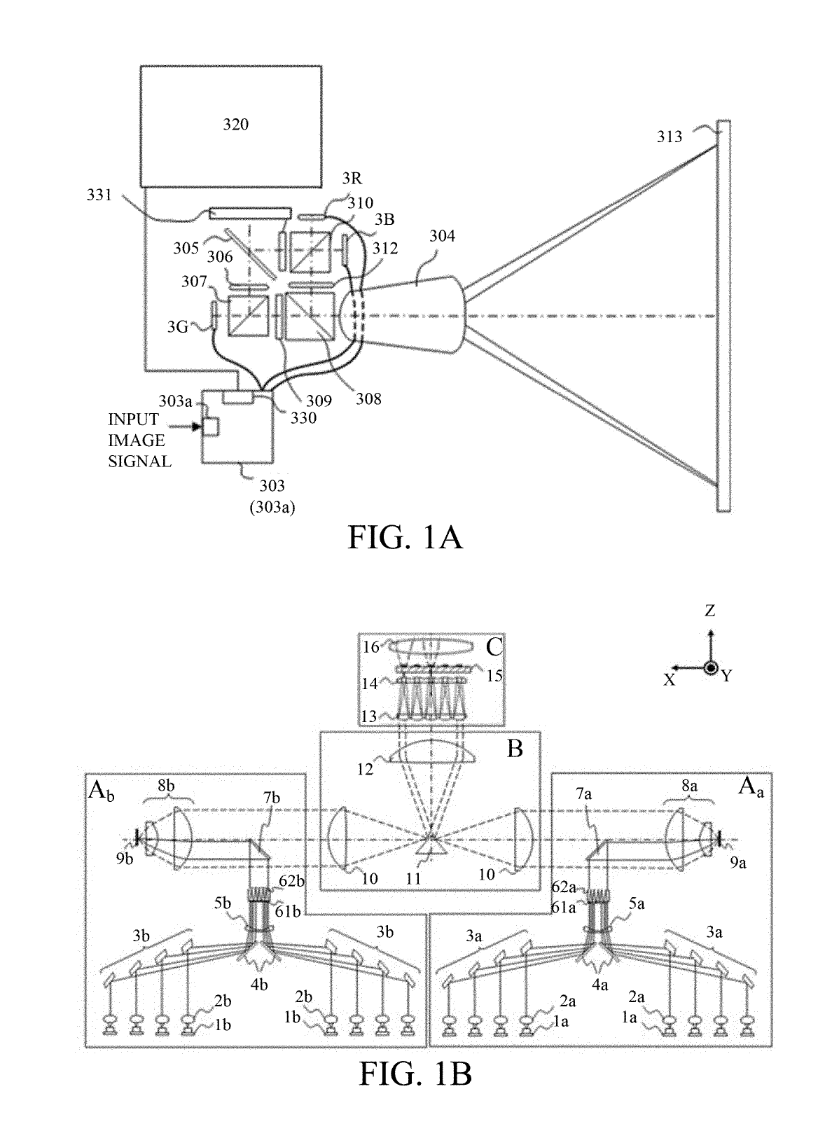

FIG. 1A illustrates an optical configuration of a liquid crystal projector as an image display apparatus according to a first embodiment of the present invention. This embodiment discusses a projector as an illustrative image display apparatus using a liquid crystal element, but the image display apparatus covers an image display apparatus using a liquid crystal element other than a projector, such as a direct view type monitor.

A liquid crystal driver 303 constitutes a liquid crystal driving apparatus, and executes liquid crystal driving processing (liquid crystal driving method) described later. The liquid crystal driver 303 includes an image input unit 303a that acquires an input image signal (input image) from an unillustrated external apparatus, and a driving circuit unit 303b that generates a pixel driving signal corresponding to gradation data described later in accordance with the gradation (input gradation) in the input image signal. The pixel driving signal is generated for each color of red, green, and blue, and the pixel driving signal for each color is input to a red(-use) liquid crystal element 3R, a green(-use) liquid crystal element 3G, and a blue(-use) liquid crystal element 3B. Thereby, the red liquid crystal element 3R, the green liquid crystal element 3G, and the blue liquid crystal element 3B are independently driven. The red liquid crystal element 3R, the green liquid crystal element 3G, and the blue liquid crystal element 3B are reflection type liquid crystal elements in the vertical alignment mode. The liquid crystal driver 303 also includes a light source controller 330 as described later.

An illumination optical system 301 aligns the polarization direction of white light as illumination light from the light source section 320, and introduces it to a dichroic mirror 305.

FIG. 1B illustrates a detailed configuration of a light source section 320. The light source section 320 includes a plurality of light source units A including a first light source unit Aa and a second light source unit Ab, an optical path combining system B including a combining prism 11 (optical path combining element), and an illumination optical system C.

Each light source unit includes a light source 1 (a first solid light source 1a, a second solid light source 1b), a collimator lens 2 (2a, 2b), a parabolic mirror array 3 (3a, 3b), a plane mirror 4 (4a, 4b), a concave lens 5 (5a, 5b), a first lens surface array 61 (61a, 61b) and a second lens surface array 62 (62b, 62b) as an integrator optical system for equalizing the light intensity distribution of the spot on a fluorescent body 9 (diffusive element), which will be described later, a dichroic mirror 7 (7a, 7b), a condenser lens unit 8 (8a, 8b), and the fluorescent body 9 (first diffusive element 9a, second diffusive element 9b). The condenser lens unit 8 takes in, collimates, and emits the fluorescent light (converted light) reflected by the fluorescent body 9. This embodiment provides two light source units, and the parallel light emitted from the first light source unit Aa and the second light source unit Ab enters the optical path combining system B including a convex lens 10, a combining prism 11, and a condenser lens 12.

The light source 1 (solid light source) is a blue LD, and a divergent light flux (or beam) emitted from the light source 1 becomes a parallel light flux by the collimator lens 2 disposed immediately after the light source 1. A single collimator lens 2 is disposed for each light source, and the number of collimator lenses is the same as that of the light sources 1. A laser beam from the collimator lens 2 travels in the Z direction and is reflected and condensed by the parabolic mirror array 3.

Each of the plurality of mirrors in the parabolic mirror array (mirror array) 3 forms part of the paraboloid having a different shape, and the laser beam reflected by the parabolic mirror array 3 is condensed and reflected by the plane mirror 4 and enters a concave lens 5. Since the focal position of the concave lens 5 corresponds to the focal position of each mirror in the parabolic mirror array 3, the concave lens 5 emits a parallel light flux. This configuration can realize a smaller illumination apparatus than that using a single parabolic mirror.

The parallel luminous flux that has emitted from the concave lens 5 enters the first lens surface array 61, is divided into divided luminous fluxes, and then enters the second lens surface array 62. The divided luminous flux that is emitted from the second lens surface array 62 is reflected by the dichroic mirror 7 and travels toward the condenser lens unit 8.

The dichroic mirror 7 has a minimum size necessary for reflecting the light flux from the second lens surface array 62. It has a dielectric multilayer film having a characteristic of reflecting the luminous flux from the light source 1 but of transmitting the fluorescent light from the fluorescent body 9.

The condenser lens unit 8 collects and superimposes the light flux reflected by the dichroic mirror 7 to form a spot on the fluorescent body 9.

The fluorescent body (diffusive element, wavelength conversion element) 9 is disposed at a position substantially conjugate with the plurality of lens surfaces on the first lens surface array 61 with respect to the second lens surface array 62 and the condenser lens unit 8. The light beam collimated by the concave lens 5 has an uneven light density distribution when entering the first lens surface array 61. The division and superimposition by the above path form a spot having a uniform light density distribution on the fluorescent body 9 similar to the lens surface shape of the first lens surface array 61. In other words, each lens surface is set to an object, and a superimposed image is formed on the fluorescent body 9. Hence, the laser beam concentrates at a single point on the fluorescent body 9, forms the locally high distribution of the light density, and can suppress the light conversion efficiency from being deteriorated by the luminance saturation phenomenon.

Part of the light flux incident on the fluorescent body 9 is converted into the fluorescent light mainly containing red and green spectra and reflected, and the rest is reflected as blue light without any wavelength conversions. The reflected white light flux composed of the three primary colors of red, green, and blue is collimated again by the condenser lens unit 8 and travels toward the optical path combining system B. While this white light flux passes through the dichroic mirror 7, the dichroic mirror 7 transmits the fluorescent light as described above, but the blue light having the same wavelength as that of the laser light flux is reflected. In other words, the blue light contained in the light flux passing through the dichroic mirror 7 out of the white light flux returns to the light source 1 side, and the light utilization efficiency drops.

In order to suppress the light utilization efficiency from dropping, it is necessary to make the area of the dichroic mirror 7 as small as possible. More specifically, in the direction orthogonal to the optical axis in the condenser lens unit 8 in the section including the normal line of the dichroic mirror 7 and the optical axis in the condenser lens unit 8, the width of the dichroic mirror 7 may be the same as that of the convergence lens unit 8. This configuration can realize a small and lightweight light source unit configured to suppress the light utilization efficiency from dropping.

The fluorescent light from the fluorescent body 9 is condensed and collimated by the condenser lens unit 8 and enters the optical path combining system B. In the optical path combining system B, the parallel light from each light source unit is condensed near the apex of the combining prism 11 by the convex lens 10. The apex or its vicinity of the synthetic prism 11 is disposed at a position substantially conjugate with the fluorescent body 9 with respect to the condenser lens unit 8 and the convex lens 10. Hence, a light source image similar in shape to the spot formed on the fluorescent body 9 is formed near the apex of the combining prism 11. The light source images of the two light source units are arranged close to each other near the apex of the combining prism 11 and can be considered as a single light source image by combining the light source images from the two light source units arranged close to each other.

The light reflected by the reflecting surface of the combining prism 11 is collimated by the condenser lens 12 and enters the illumination optical system C.

The light entering the illumination optical system C is converted into divided luminous fluxes by a first fly-eye lens 13, and a light source image is formed again near a second fly-eye lens 14. The second fly-eye lens 14 is disposed at a position substantially conjugate with the vicinity of the apex of the combining prism 11 in the optical path combining system B with respect to the condenser lens 12 and the first fly-eye lens 13. The light source image formed near the second fly-eye lens 14 has a similar shape to the light source image formed near the apex of the combining prism 11.

According to the above conjugate relationship among the respective elements, the position of the second fly-eye lens 14 is substantially conjugate with the fluorescent body 9 and the first lens surface array 61 via the vicinity of the apex of the combining prism 11. The shape of the light source image formed near the second fly-eye lens 14 is similar to each lens surface of the first lens surface array 61.

The divided luminous fluxes from the first fly-eye lens 13 are condensed and superimposed on the liquid crystal element 3 via the second fly-eye lens 14, the condenser lens 16, a dichroic mirror 305 described later, and the like.

Since the fluorescent light from the light source unit is nonpolarized light, the polarization conversion element 15 is disposed just behind the second fly-eye lens 14 in order to improve the light utilization efficiency. The polarization converting element 15 arranges a plurality of elongated polarization beam splitters having a width of about one half of the lens cells in the second fly-eye lens 14 and alternately arranges other half waveplate on the exit surface of the polarization beam splitter. The polarization conversion element 15 may be configured such that the light shield is alternately provided at a position shifting from the half waveplate.

The illumination light from the condenser lens 16 enters a light control element 331. The light control element 331 includes a liquid crystal element or the like and is an element capable of changing the intensity of the illumination light traveling from the light source section 320 to the liquid crystal element 3. The illumination light whose intensity is controlled by the light control element 331 travels to the dichroic mirror 305. The intensity of the illumination light moving to the liquid crystal element 3 may be changed by changing the emission intensity of the light source 1 without providing the light control element 331.

The dichroic mirror 305 reflects the magenta light and transmits the green light. The magenta light reflected by the dichroic mirror 305 enters a blue cross color polarizer 311, where blue light and red light with polarization directions orthogonal to each other are generated because only the blue light receives a half wavelength retardation. The blue light and the red light enter a polarization beam splitter 310, and the blue light transmits through the polarization splitting film in the polarization beam splitter 310 and is guided to the blue liquid crystal element 3B. The red color component is reflected by the polarization splitting film and guided to the red liquid crystal element 3R.

On the other hand, the green light that has passed through the dichroic mirror 305 passes through a dummy glass 306 configured to correct an optical path length, enters the polarizing beam splitter 307, is reflected by the polarization splitting film, and is led to the green liquid crystal element 3G.

Each liquid crystal element (3R, 3G, 3B) modulates and reflects the incident light according to the modulation state of each pixel. The red light modulated by the red liquid crystal element 3R transmits through the polarization splitting film in the polarizing beam splitter 310, enters a red cross color polarizer 312, and receives a half wavelength retardation. Then, the red light enters a polarization beam splitter 308, is reflected by the polarization splitting film, and travels to a projection optical system 304.

The blue light modulated by the blue liquid crystal element 3B is reflected by the polarization splitting film in the polarization beam splitter 310, passes through the red cross color polarizer 312 as it is, is reflected by a polarization splitting film in a polarization beam splitter 308, and travels to the projection optical system 304. The green light modulated by the green liquid crystal element 3G transmits through the polarization splitting film in the polarization beam splitter 307, passes through a dummy glass 309 configured to correct the optical path length, transmits the polarization splitting film in the polarization beam splitter 308, and travels to the projection optical system 304. Thus, the combined red, green, and blue light fluxes enter the projection optical system 304. Then, the combined color light is enlarged and projected onto a projected surface 313, such as a screen, by the projection optical system 304.

This embodiment discusses a reflection type liquid crystal element, but may use a transmission type liquid crystal element.

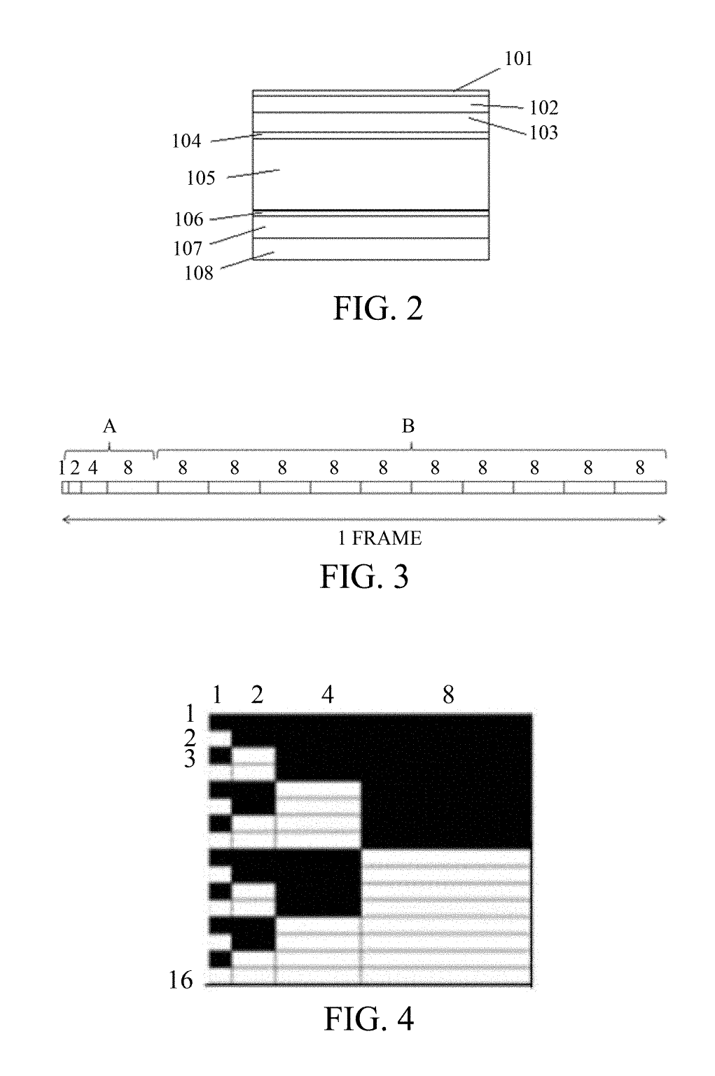

FIG. 2 illustrates the sectional structure of the reflective liquid crystal elements (3R, 3G, 3B). Reference numeral 101 denotes an antireflection (AR) coating film, reference numeral 102 denotes a glass substrate, reference numeral 103 denotes a common electrode, reference numeral 104 denotes an alignment film, reference numeral 105 denotes a liquid crystal layer, reference numeral 106 denotes an alignment film, reference numeral 107 denotes a pixel electrode, and reference numeral 108 denotes a Si substrate.

The liquid crystal driver 303 illustrated in FIGS. 1A and 1B drives each pixel based on the above subframe driving method. This method divides one frame period into a plurality of subframe periods on the time axis, controls turning on (applying) and turning off (nonapplying) the predetermined voltage to the pixel for each subframe period in accordance with the gradation data, and forms (displays) the gradation on the pixel. One frame period is a period for displaying a one-frame image on the liquid crystal element. This embodiment drives the liquid crystal element at 120 Hz and sets the one frame period to 8.33 ms. Turning on and off the predetermined voltage may mean applying a first voltage (predetermined voltage) and applying a second voltage lower than the first voltage.

Next follows a description of the subframe period setup and the gradation data in the liquid crystal driver 303. The liquid crystal driver 303 may include a computer, and control setting of the subframe period and turning on and off the predetermined voltage for each subframe period in accordance with the liquid crystal driving program as the computer program.

FIG. 3 illustrates one frame period divided into a plurality of subframes (bit lengths) according to this embodiment. A numeral value on each subframe means a time weight on the subframe in one frame period. This embodiment expresses 96 gradations. This embodiment refers to a period for the time weight of 1+2+4+8 as an A subframe period (first period), and refers to a bit representative of a gradation binarized in the A subframe period as a low-order (or lower) bit. In addition, this embodiment refers to 10 subframes with the time weight of 8 as a B subframe period (second period), and refers to a bit representative of a gradation binarized in the B subframe period as a high-order (or upper) bit. The time weight of 1 corresponds to 0.087 ms, and the time weight of 8 corresponds to 0.69 ms.

In addition, the subframe period used to turn on the above predetermined voltage (or to apply the first voltage) will be referred to as an ON period, and the subframe period used to turn off the above predetermined voltage (or to apply the second voltage) will be referred to as an OFF period.

FIG. 4 illustrates gradation data in the A subframe period illustrated in FIG. 3. The ordinate axis denotes a gradation, and the abscissa axis denotes one frame period. The A subframe period expresses 16 gradations. In FIG. 4, a white subframe period represents the ON period in which the above predetermined voltage is applied so as to display the pixel in white, and a black subframe period represents the OFF period in which the above predetermined voltage is not applied so as to display the pixel in black.

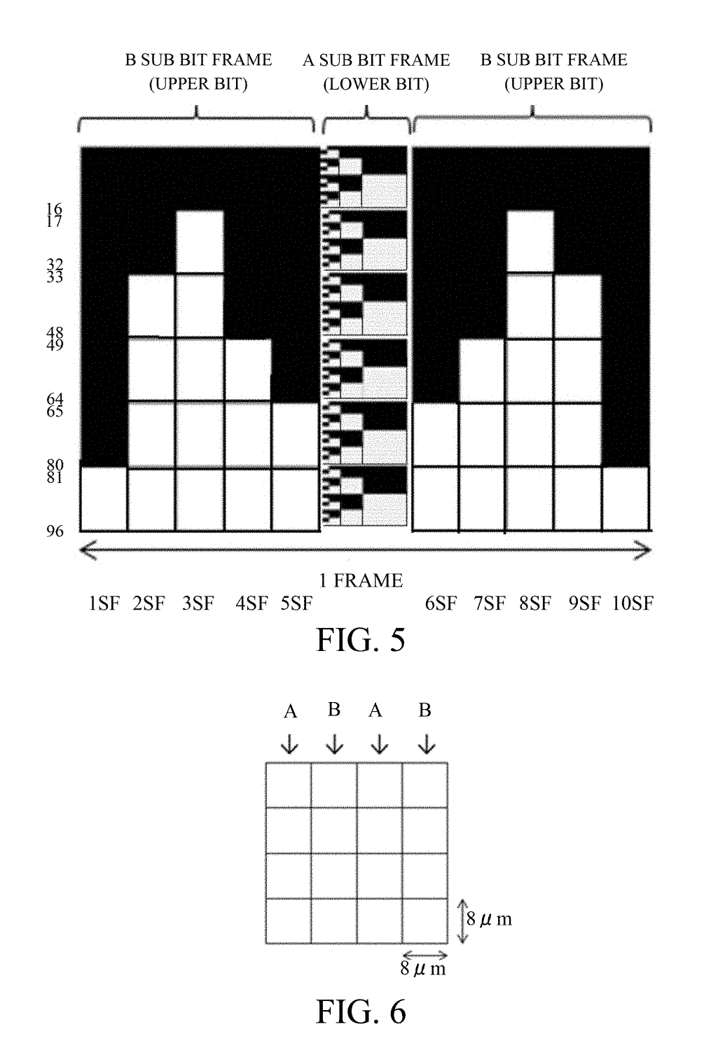

FIG. 5 illustrates gradation data in the A and B subframe periods (low-order and high-order bits) according to this embodiment. This gradation data is used to express all 96 gradations. In this gradation data, the A subframe period (low-order bit) is disposed at the center of the one frame period, and the B subframe period (high-order bit) is divided into 1SF to 5SF and 6SF to 10SF and arranged before and after the A subframe period. In other words, the B subframe period is divided into two, and each B subframe period contains two or more subframe periods.

According to this gradation data, in order to display two adjacent gradations, such as 48^{th} and 49^{th} gradations, on two adjacent pixels in the liquid crystal element, the A subframe period is set to the ON period for the 48^{th} gradation and to the OFF period for the 49^{th} gradation. 1SF, 4SF, 5SF, 6SF, 7SF, and 10SF are set to the OFF period and 2SF, 3SF, 8SF and 9SF are set to the ON period for the 48^{th} gradation among the B subframe periods. On the other hand, 1SF, 5SF, 6SF, and 10SF are set to the OFF period and 2SF, 3SF, 4SF, 7SF, 8SF and 9SF are set to the ON period for the 49^{th} gradation among the B subframe periods. In order to display these adjacent gradations on adjacent pixels, ON/OFF adjacent periods occur in which the ON period and the OFF period are concurrent with each other between the adjacent pixels. More specifically, in order to display the 48^{th} and 49^{th} gradations on the adjacent pixels, 4SF and 7SF among the B subframe periods are the ON/OFF adjacent periods.

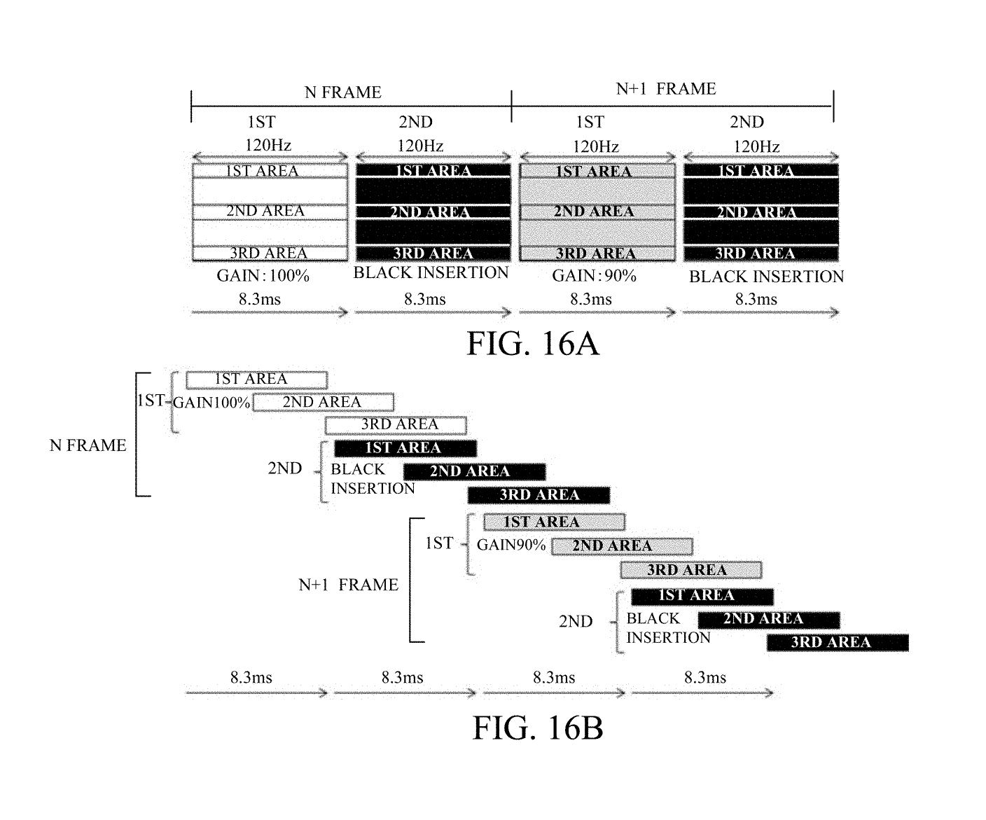

Now the gradation data according to this embodiment is compared with that in the prior art (JP 2013-050681) illustrated in FIG. 22. The B subframe period as a whole follows the A subframe period in the gradation data in FIG. 22, whereas the B subframe periods are divided and arranged before and after the A subframe period in the gradation data illustrated in FIG. 5 according to this embodiment. For example, when the 48^{th} and 49^{th} gradation are addressed, 5SF and 6SF are the ON/OFF adjacent periods in the B subframe period in FIGS. 22 and 16 ON/OFF periods continue as the time weight. This is similarly applied to the 16^{th} and 17^{th} gradations, the 32^{nd} and 33^{rd} gradations, the 64^{th} and 65^{th} gradations, the 80^{th} and 81^{st} gradation, etc. On the other hand, according to this embodiment illustrated in FIG. 5, the ON/OFF periods in the B subframe period continue for one subframe period (=0.69 ms) with the time weight of 8 for any of the above adjacent gradations. The two ON/OFF periods in this one subframe period are separated from each other via the A subframe period.

Next follows a description of the effect obtained by the distributed ON/OFF periods as in this embodiment.

A description will now be given of a liquid-crystal response characteristic when a pixel matrix array illustrated in FIG. 6 is switched from the all-white display state to the monochromatic display state for displaying each pixel line in black and white alternately and from the all-black display state to the monochromatic display state. 4×4 pixels illustrated in FIG. 6 are arranged in a matrix shape with a pixel pitch of 8 μm. In the all-white display state, each of the pixels on the A pixel line and the pixels on the B pixel line is displayed in white in FIG. 6. In the monochromatic display state, the pixels on the A pixel line turn from the white display state to the black display state, and the pixels on the B pixel line maintain the white display states.

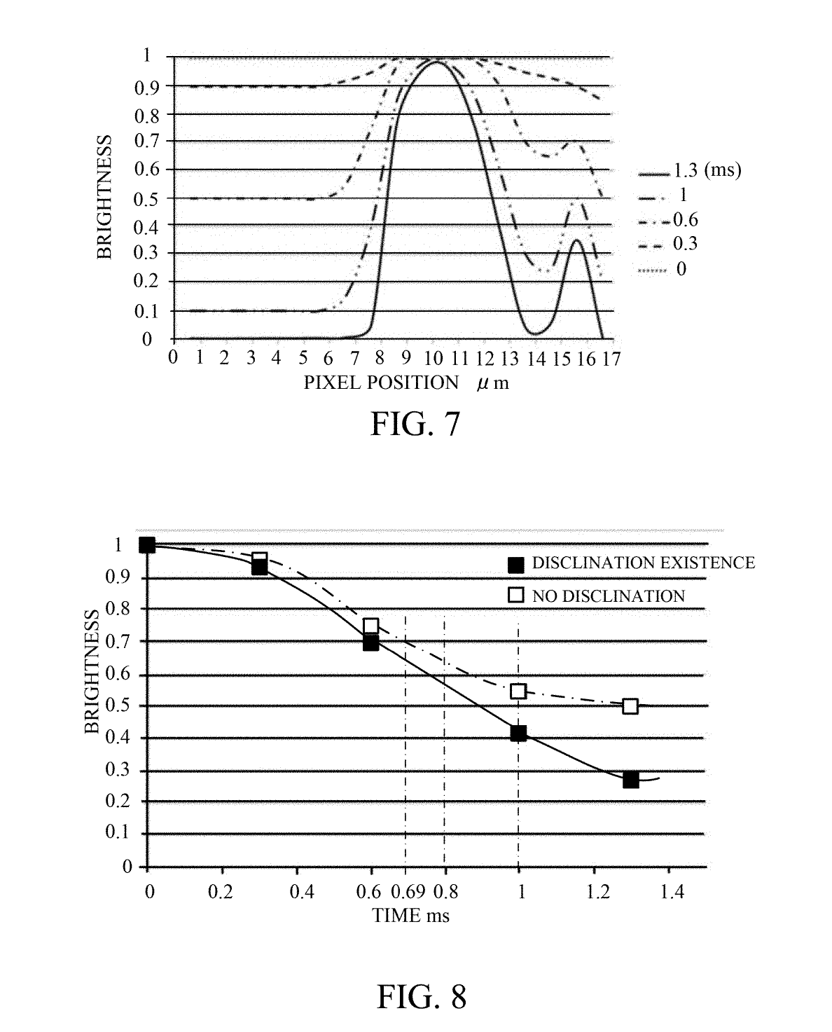

FIG. 7 illustrates the liquid-crystal response characteristic. The abscissa axis denotes a pixel position, and the ordinate axis denotes the brightness in each pixel that is a ratio where white is set to 1. 0 to 8 μm on the abscissa axis denotes the pixel on the A pixel line illustrated in FIG. 6, and 8 to 16 μm denotes the pixel on the B pixel line. Each curve illustrates the brightness as time passes (0.3 ms, 0.6 ms, 1.0 ms, and 1.3 ms) when the all-white display state is switched to the monochromatic display state at time 0 ms.

As described above, when the pixel on the A pixel line switches from the white display state to the black display state, the brightness comparatively uniformly changes (darkens) in the pixel on the A pixel line from a pretilt angle orientation relationship in the liquid crystal without being influenced by the disclination. On the other hand, no disclination occurs in the pixel on the B pixel line in the all-white display state. However, after the pixels turn into the monochromatic display state, the brightness curve gradually distorts with time under influence of the disclination and comes to include dark lines, in particular from about 12 μm to about 16 μm.

In general, the gamma curve (gamma characteristic) for determining a drive gradation of the liquid crystal element in response to an input gradation is prepared based on a response characteristic that is made by changing a gradation while this gradation is displayed on the whole surface of the liquid crystal element having no disclination. Hence, when the liquid crystal element is driven with this gamma curve, the disclination occurs in the monochromatic display state and the brightness is lower than the original brightness due to the gamma curve.

FIG. 8 illustrates a brightness change due to the disclination when the liquid crystal element is switched from the all-white state to the monochromatic display state. The abscissa axis is an elapsed time from the switching time, and the ordinate axis is a change of an integral value (simply referred to as “brightness” hereinafter) of the total brightness on the pixels on the A and B pixel lines. The brightness illustrates a ratio where the all-white display state is set to 1. When the disclination occurs (“disclination existence”), the brightness in the pixel on the A pixel line changes with a characteristic close to the response characteristic from 1 to 6 μm in FIG. 7, and the brightness in the pixel on the B pixel line becomes a white display state with the brightness of 100%. As the following time passes, a brightness reduced amount with the disclination is larger than that with (“no disclination”).

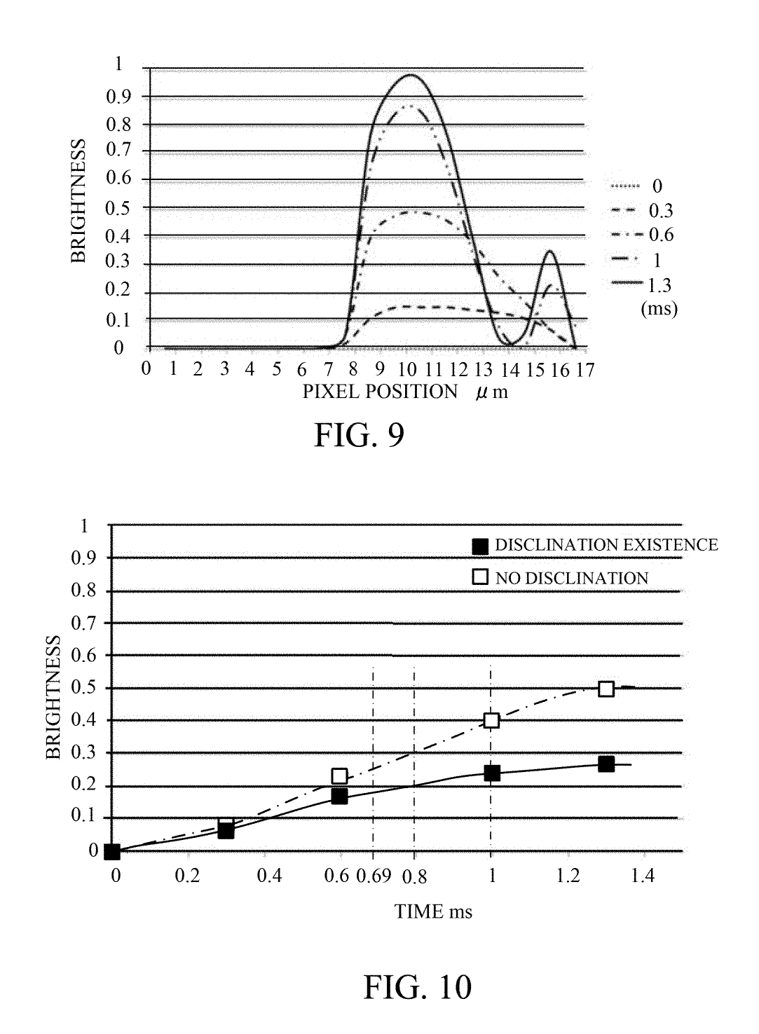

On the other hand, when the all-black display state is switched to the monochromatic display state, after the pixels on the A pixel line and the pixels on the B pixel line illustrated in FIG. 6 are displayed in black, the pixel on the A pixel line is maintained in the black display state and the pixel on the B pixel line is changed to the white display state. FIG. 9 illustrates the liquid-crystal response characteristic at this time. The abscissa axis denotes the pixel position, and the ordinate denotes the brightness in each pixel having a ratio where white is set to 1. 0 to 8 μm on the abscissa axis denote the pixel on the A pixel line and 8 to 16 μm denote the pixel on the B pixel line in FIG. 6. Each curve illustrates the brightness for each elapsed time (0.3 ms, 0.6 ms, 1.0 ms, and 1.3 ms) when the all-black display state is switched to the monochromatic display state at time 0 ms.

As described above, when the pixel on the B pixel line switches from the black display state to the white display state, the brightness curve in the pixel on the B pixel line gradually distorts under influence of the disclination after the white display state as time elapses and comes to include dark lines, in particular from about 12 μm to about 16 μm. The distorted curve shape becomes remarkable as the time elapses.

As described above, in general, the gamma curve (gamma characteristic) for determining a drive gradation of the liquid crystal element in response to an input gradation is prepared based on a response characteristic that is made by changing a gradation while this gradation is displayed on the whole surface of the liquid crystal element having no disclination. Hence, when the liquid crystal element is driven with this gamma curve, the disclination occurs in the monochromatic display state and the brightness is lower than the original brightness due to the gamma curve.

FIG. 10 illustrates a brightness change due to the disclination when the liquid crystal element is switched from the all-black state to the monochromatic display state. The abscissa axis is an elapsed time from the switching time, and the ordinate axis is a change of an integral value (simply referred to as “brightness” hereinafter) of the total brightness on the pixels on the A and B pixel lines. The brightness illustrates a ratio where the all-white display state is set to 1. When no disclination occurs (“no disclination”), the brightness changes while the pixel on the A pixel line is always the black display state and the pixel on the B pixel line changes from the black display state to the white display state. When the disclination occurs (“disclination existence”), the brightness changes as a change of the integral value of a sum of the brightness of the pixel on the A pixel line and the brightness of the pixel on the B pixel line as in FIG. 9.

In FIG. 10, when the disclination occurs, an increase amount of the brightness associated with time is less than that when no disclination occurs. In other words, as a disclination period is longer after the state is switched from the all-black display state to the monochromatic display state, the brightness is lower than that where no disclination occurs.

Next follows a description where the pixels on the A pixel line display the 48^{th} gradation and the pixels on the B pixel line display the 49^{th} gradation with the conventional gradation data illustrated in FIG. 22. With this gradation data, the disclination occurs in 5SF and 6SF in the B subframe periods in which the pixels on the A pixel line are displayed in black and the pixels on the B pixel line are displayed in white. In 4SF before 5SF, each of the pixels on the A pixel line and the pixels on the B pixel line is displayed in white and no disclination occurs.

The liquid-crystal response characteristic from 5SF to 6SF corresponds to the characteristic “disclination existence” in FIG. 8. The all-white display state in 4SF has the output brightness of 100%, and the disclination occurs in a period of 1.39 ms from when 5SF starts to when 6SF ends. The start time of 5SF corresponds to 0 ms, and the end time of 6SF corresponds to 1.39 ms in FIG. 8. Then, the brightness lowers down to 0.27 whereas the brightness lowers down to 0.5 when no disclination occurs. As described above, based on the gamma characteristic prepared with the same gradation on the entire surface, the ratio becomes as dark as 54% (=0.27/0.5) in the disclination period from 5SF to 6SF.

Next follows a description of this embodiment where the pixels (second pixel) on the A pixel line display the 48^{th} gradation with the gradation data illustrated in FIG. 5 and the pixels (first pixel) on the B pixel line display the 49^{th} gradation. With this gradation data, the disclination occurs in 4SF and 7SF in the B subframe periods in which the pixels on the A pixel line and the pixels on the B pixel line display the disclination. In 3SF before 4SF, each of the pixels on the A pixel line and the pixels on the B pixel line is displayed in white and no disclination occur.

The liquid-crystal response characteristic in 4SF corresponds to a characteristic “disclination existence” in FIG. 8. The all-white display state in 3SF has the output brightness of 100%. The disclination occurs in a period of 0.69 ms in 4SF, the start time of 4SF corresponds to 0 ms, and the end time of 4SF corresponds to 0.69 ms in FIG. 8. Then, the brightness lowers down only to 0.65 whereas the brightness lowers down to 0.7 when no disclination occurs.

The other liquid-crystal response characteristic in 7SF in the disclination subframe period corresponds to a characteristic “disclination existence” in FIG. 10. The all-black display state in 6SF has the output brightness of 0%, and the disclination occurs in a period of 0.69 ms in 7SF. The start time of 7SF corresponds to 0 ms, and the end time of 7SF corresponds to 0.69 ms in FIG. 10. Then, the brightness lowers down only to 0.18 whereas the brightness lowers down to 0.25 when no disclination occurs.

A sum of the brightness with no disclination in 4SF and 7SF is 0.95 (=0.70+0.25) whereas that with the disclination is 0.83 (=0.65+0.18). As described above, based on the gamma characteristic prepared with the same gradation on the entire surface, the brightness is as dark as a ratio of 87% (=0.83/0.95) in the disclination display state. In other words, this embodiment can restrain a brightness drop.

Next follows a description of displaying other adjacent gradations. Initially, a description will be given where the pixels on the A pixel line illustrated in FIG. 6 display the 16^{th} gradation and the pixels on the B pixel line display the 17^{th} gradation with the conventional gradation data illustrated in FIG. 22. With the gradation data, the disclination occurs in 1SF and 2SF in the B subframe period in which the pixels on the A pixel line are displayed in black and the pixels on the B pixel line are displayed in white.

The liquid-crystal response characteristic from 1SF to 2SF corresponds to a characteristic “disclination existence” in FIG. 10. The disclination occurs in a period of 1.39 ms from when 1SF starts to when 2SF ends. The start time of 1SF corresponds to 0 ms, and the end time of 2SF corresponds to 1.39 ms in FIG. 10. Then, the brightness lowers down to 0.27 whereas the brightness lowers down to 0.5 when no disclination occurs. As described in the first embodiment, based on the gamma characteristic prepared with the same gradation on the entire surface, the brightness is as dark as a ratio of 54% (=0.27/0.5) in the disclination period from 1SF to 2SF.

Next follows a description of this embodiment where the pixel (second pixel) on the A pixel line displays the 16^{th} gradation with the gradation data illustrated in FIG. 5 and the pixel (first pixel) on the B pixel line displays the 17^{th} gradation. With the gradation data, the disclination occurs in 3SF and 8SF in the B subframe periods in the disclination display state of the pixels on the A pixel line and the pixels on the B pixel line. In 2SF before 3SF, each of the pixels on the A pixel line and the pixels on the B pixel line displays black and no disclination occurs. The liquid-crystal response characteristic in 3SF corresponds to a characteristic “disclination existence” in FIG. 10. The all-black display state in 2SF has the output brightness of 0%, and the disclination occurs in a period of 0.69 ms in 3SF. The start time of 3SF corresponds to 0 ms, and the end time of 3SF corresponds to 0.69 ms in FIG. 10. Then, the brightness lowers down only to 0.18 whereas the brightness lowers down to 0.25 when no disclination occurs.

The other liquid-crystal response characteristic in 8SF in the disclination subframe period corresponds to a characteristic “disclination existence” in FIG. 10. The all-black display state in 7SF has the output brightness of 0%, and the disclination occurs in a period of 0.69 ms in 8SF. The start time of 8SF corresponds to 0 ms, and the end time of 8SF corresponds to 0.69 ms in FIG. 10. Then, the brightness lowers down only to 0.18 whereas the brightness lowers down to 0.25 when no disclination occurs.

A sum of the brightness with no disclination in 3SF and 8SF is 0.50 (=0.25+0.25) whereas that with the disclination is 0.36 (=0.18+0.18). As described above, based on the gamma characteristic prepared with the same gradation on the entire surface, the disclination display state is as dark as a ratio of 72% (=0.36/0.95). In other words, this embodiment can restrain a brightness drop.

Thus, this embodiment separates (distributes) a plurality of ON/OFF periods as the disclination display states from each other in the one frame period in displaying the adjacent gradations, and shortens the one continuing ON/OFF period. In other words, before the brightness drop caused by the disclination stands out, the disclination display state in the adjacent pixels may be transferred to another display state. This configuration can restrain the brightness drop caused by the disclination, makes less conspicuous the dark lines, and can display a good-quality image.

The above liquid crystal element driving method (referred to as a “first driving method” hereinafter) can restrain the disclination. However, in order to further prevent the dark lines from standing out, this embodiment can also use the following driving method (referred to as a “second driving method” hereinafter). In addition, this embodiment performs a so-called black insertion that inserts a frame (or subframe) for performing black display between motion image displaying frames (or subframes) in order to improve the visibility of the motion images.

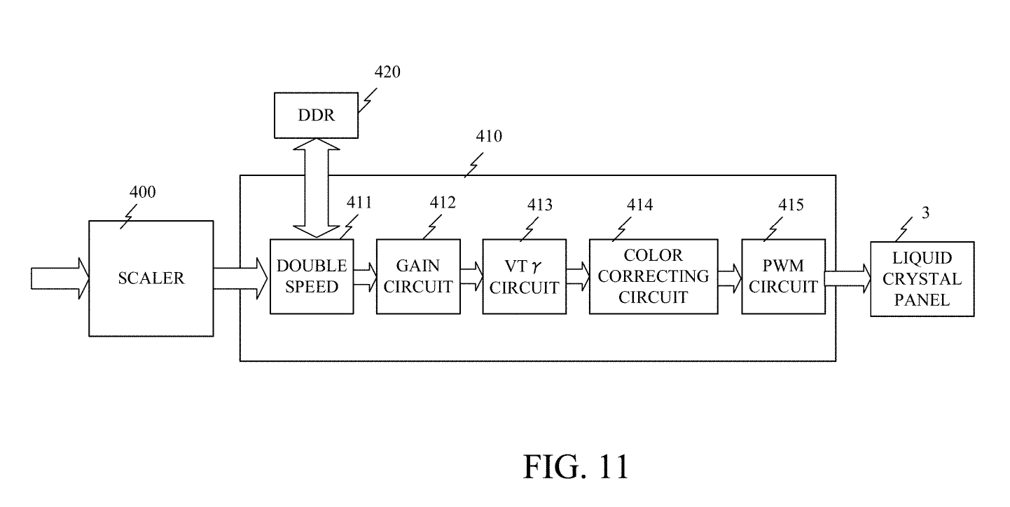

FIG. 11 illustrates an internal configuration of the liquid crystal driver 303. The scaler 400 corresponds to the image input unit 303a illustrated in FIG. 1, and takes in an input image signal via an unillustrated receiver IC such as DVI or HDMI (registered trademarks). The scaler 400 down-converts or up-converts an input image signal by its scaling function and outputs input image data in a predetermined image format. The input image data as motion image data contains a plurality of consecutive input frame image data.

The driving circuit unit 303b sequentially receives the input frame image data from the scaler 400 and drives each pixel in the liquid crystal element 3 (the three liquid crystal elements 3R, 3G, and 3B illustrated in FIGS. 1A and 1B) or generates a pixel driving signal that enables each pixel to display the gradation. The driving circuit unit 303b includes a double-speed circuit 411, a gain circuit 412, a VTγ circuit 413, a color correcting circuit 414, and a PWM circuit 415.

The double-speed circuit 411 writes each input frame image data in a frame memory (DDR) 420, and generates a plurality of double-speed frame image data (referred to as “double-speed frame image data” hereinafter). For example, when the input frame image data has an input frequency of 60 Hz, two double-speed frame image data are generated at 120 Hz, and four double-speed frame image data are generated at 240 Hz.

The gain circuit 412 multiplies the double-speed frame image data from the double-speed circuit 411 by a gain or gain coefficient. The gain circuit 412 can change the gain for each double-speed frame image data. The double-speed circuit 411 and the gain circuit 412 constitute the image data generator.

The VTγ circuit 413 performs a γ correction for the output frame image data from the gain circuit 412 so as to obtain the necessary optical characteristic according to the gradation characteristic that varies depending on the liquid crystal response characteristic in the liquid crystal element 3.

The color correcting circuit 414 corrects the uneven color in the optical system in the projector including the liquid crystal panel 3 for the output frame image data after the γ correction from the VTγ circuit 413.

The PWM circuit (driver) 415 drives the liquid crystal element 3 by the above subframe driving method based on the output frame image data from the color correcting circuit 414.

In each of the double-speed frame image data sequentially input to the gain circuit 412, the pixel data at two adjacent pixel positions corresponding to the adjacent pixels have the 48^{th} and 49^{th} gradations. In the following description, the pixel data at the adjacent pixel positions will be referred to as adjacent pixel data.

The gain circuit 412 changes the gain applied to the double-speed frame image data sequentially input from the double-speed circuit 411 at 120 Hz (or at a double speed) as illustrated in FIG. 16A for each double-speed frame image data. In other words, the gain circuit 412 cyclically changes the gain in order of 100% (a first gain), 0% (black insertion gain, a third gain lower than a second gain described below), 90% (the second gain lower than the first gain), and 0% (the gain for the black insertion). Thereby, in the N^{th} frame, output frame image data (first) as first display image data of 100% gain is generated and then output frame image data (second) as 0% gain of the black insertion image data is generated. In the next (N+1)^{th} frame, output frame image data (first) as the second display image data of the 90% gain is generated and output frame image data (first) as the 0% gain of the black insertion image data (second) is generated.

The adjacent pixel data in the output frame image data of the 100% gain (referred to as “bright output frame image data” hereinafter) have the 48^{th} and 49^{th} gradations. On the other hand, the adjacent pixel data in the output frame image data of the 90% gain (hereinafter referred to as dark output frame image data) have the 43^{th} and 44^{th} gradations (while rounded off to the decimal point). Driving the liquid crystal element 3 by alternately supplying the bright output frame image data and the dark output frame image data which is not used for the black insertion will be referred to as bright and dark driving. The bright and dark driving, as will be detailed later, can make the dark line caused by the disclination less conspicuous in the display image (projection image). The gain circuit 412 sets the sum of the first and second gains in frames following the (N+2)^{th} frame to be equal to the sum of the first and second gains (100%+90%=190%) in the N^{th} and (N+1)^{th} frames.

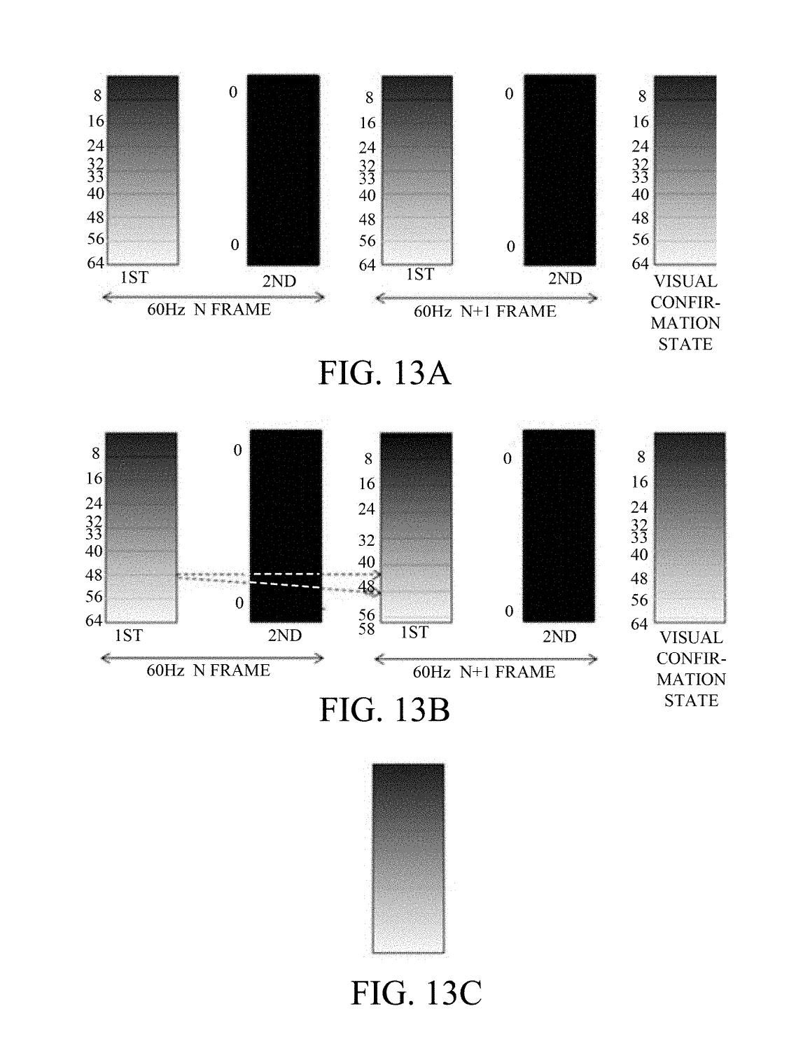

FIG. 13A illustrates display images in the N^{th} and (N+1)^{th} frames (referred to as a “bright display images” hereinafter) when the liquid crystal element 3 is driven based only on the bright output frame image data and the black insertion output frame image data (referred to as “black insertion frame image data” hereinafter) and the black insertion image. FIG. 13C illustrates a display image to be originally displayed. In FIG. 13A, the bright display images in the N^{th} and (N+1)^{th} frames both have 0^{th} to 64^{th} gradations from the upper end to the lower end. Images (referred to as a “visually confirmed image” hereinafter) visually confirmed by an observer who continuously observes N^{th} and (N+1)^{th} frames is illustrated on the rightmost side in the figure. In this figure, the pixels at the corresponding pixel positions in the bright display image in the N^{th} and (N+1)^{th} frames have the same gradations. As a result, the dark lines caused by the disclination appear at positions such as 16^{th} to 17^{th}, 32^{th} to 33^{th}, and 48^{th} to 49^{th} gradations in both bright display images in the N^{th} and (N+1)^{th} frames. Although dark lines are thickly illustrated in the figure for clarity, the liquid crystal element 3 is actually driven by the above first driving method and only thin dark lines appear. However, the observer can visually confirm the dark lines.

FIG. 13B illustrates a display image (referred to as a “dark display image” hereinafter) when the liquid crystal element 3 is driven based on the dark output frame image data in addition to the bright display image and the black insertion image corresponding to the bright output frame image data and the black insertion frame image data. The bright display image in the N^{th} frame has the 0^{th} to 64^{th} gradations corresponding to the 100% gain from the upper end to the lower end. In contrast, the dark display image in the (N+1)^{th} frame has the 0^{th} to 58^{th} gradations corresponding to the 90% gain from the upper end to the lower end. Thereby, the position of the dark line caused by the disclination in the N^{th} frame differs or shifts from the position of the dark line in the (N+1)^{th} frame. For example, the position “a” of the dark line in the N^{th} frame (such as the positions of 48^{th} to 49^{th} gradations) shifts from the position “b” of the dark line in the (N+1)^{th} frame. Hence, the dark line concentration is averaged between the N^{th} frame and the (N+1)^{th} frame in the visually confirmed image illustrated on the rightmost side in the figure, and the dark line has a concentration of about half of the concentration of each frame. As a result, the dark line can be made less conspicuous than that where only the liquid crystal element 3 is driven by the first driving method.

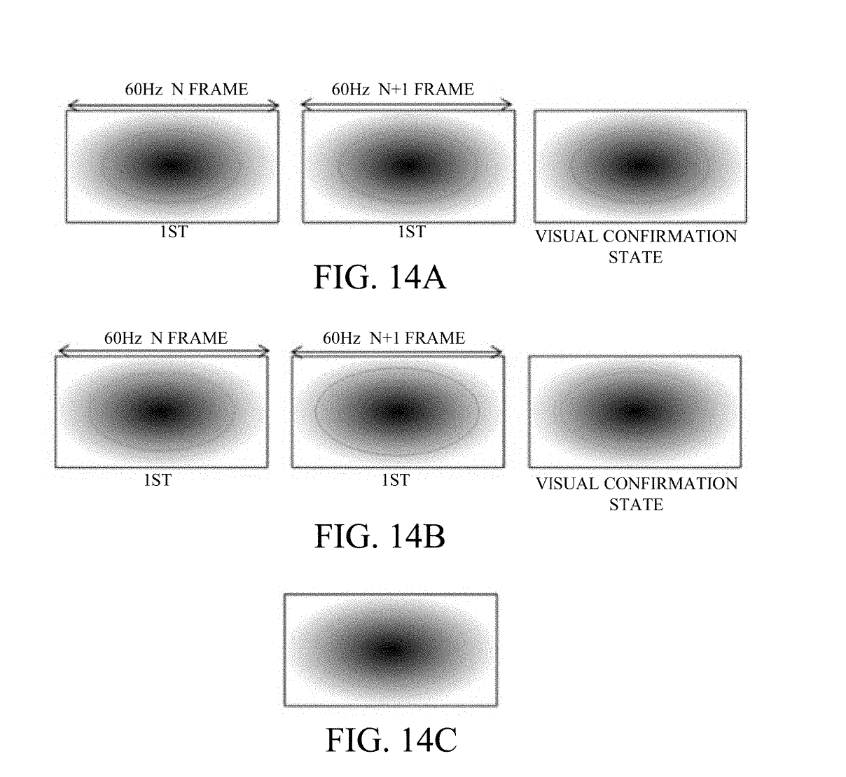

FIGS. 14A and 14B illustrate a more specific example of a display image. FIG. 14C illustrates a display image to be originally displayed. FIG. 14A illustrates the bright display images displayed in the N^{th} and (N+1)^{th} frames as described in FIG. 13A. A visually confirmed image is illustrated on the rightmost side in the figure. Since the position of the dark line caused by the disclination in the N^{th} frame is the same as that in the (N+1)^{th} frame, the dark line is conspicuous to some extent also in the visually confirmed image.

On the other hand, FIG. 14B illustrates the bright display image and the dark display image displayed in each of the N^{th} and (N+1)^{th} frames as described with reference to FIG. 13B. A visually confirmed image is illustrated on the rightmost side in the figure. The brightest gray level outside each display image has the 64^{th} gradation in the bright display image in the N^{th} frame and the 58^{th} gradation in the dark display image in the N^{th} frame, and the dark line position caused by the disclination in the N^{th} frame shifts from that in the (N+1)^{th} frame. For this reason, in the visually confirmed image illustrated on the leftmost side in the figure, the dark line concentrations are averaged among the N^{th} and (N+1)^{th} frames and the dark line is made almost inconspicuous.

Thus, the second driving method generates the bright and dark output frame image data such that pixel data at the corresponding pixel positions have gradations different from each other, and drives the liquid crystal element 3 in the N^{th} and (N+1)^{th} frames based on the bright and dark output frame image data. Thereby, the positions of the dark lines in the N^{th} and (N+1)^{th} frames shift from each other, so that the dark line can be made inconspicuous in the visually confirmed image.

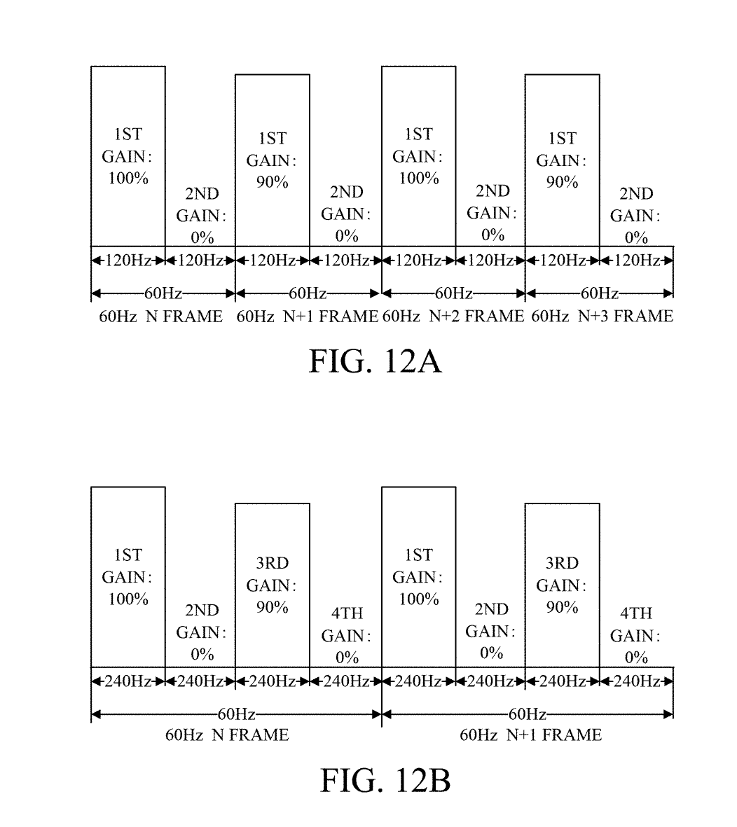

This embodiment has described the gain circuit 412 that has changed the gain applied to the double-speed frame image data sequentially input from the double-speed circuit 411 at the double speed, for each double-speed frame image data, but the double-speed value is not limited to this example. For example, the gain circuit 412 may change the gain applied to the double-speed frame image data sequentially input from the double-speed circuit 411 at 240 Hz (or at the quadruple speed) for each double-speed frame image data. Then, for example, as illustrated in FIG. 12B, the gain applied to the first double-speed frame image data in the N^{th} frame is set to 100%, and the gain applied to the second double-speed frame image data is set to 0% for the black insertion. The gain applied to the third double-speed frame image data of the same N^{th} frame is set to 90%, and the gain applied to the fourth double-speed frame image data is set to 0% for the black insertion. The first double-speed frame image data and the third double-speed frame image data are image data generated from the same input frame image data and are the same image data. Similarly, the gains applied to the first, second, third, and fourth double-speed frame image data in the (N+1)^{th} frame are set to 100%, 0%, 90% and 0%, respectively.

The example in FIGS. 12A and 12B discusses the gain used for generating the bright and dark output frame image data that is repeatedly changed between 100% and 90%. Whenever the bright output and dark output frame image data is generated, at least one of the gains for them may be changed. For example, in the example of FIG. 12A, the gain in the N^{th} frame may be set to 100%, the gain in the (N+1)^{th} frame may be set to 90%, the gain in the (N+2)^{th} frame may be set to 97.5%, and the gain in the (N+₃)^{th} frame may be set to 92.5%. Thereby, the disclination position is different among four consecutive frames, and the concentration of the dark line in the visually confirmed image can be made about quarter of that in each frame. Then, these gains may be changed so that the sum of the pre-change gains is the same as that of the post-change gains for the bright and dark output frame image data. Thereby, the brightness fluctuation in the display image caused by the gain change can be made inconspicuous.

A difference between the gain for the bright output frame image data and the gain for the dark output frame image data may be 2% or more and 20% or less of the gain for the bright output frame image data.

This embodiment describes the black insertion, but the same effect can be obtained by the bright and dark driving. In the bright and dark driving, the bright frame in the bright and dark driving can obtain the effect through the gain setting similar to that of a display frame (frame that is not for the black insertion) in the black insertion. The dark frame in the bright and dark driving can also obtain the effect by changing the gain setting for each frame (for example, setting it to a gain higher than 0% gain in the black insertion). Hence, the disclination reducing effect can be obtained by changing the gain for each frame for both bright and dark frames in the bright and dark driving as in the black insertion according to this embodiment.

The black insertion gain is 0% or more and less than 80% and may be a gain lower than the above first and second gains. When the liquid crystal element 3 is driven based on the black insertion frame image data, the intensity of the illumination light entering the liquid crystal element 3 may be lower than that when the liquid crystal element 3 is driven based on the bright output frame image data. For example, when the liquid crystal element 3 is driven based on the black insertion frame image data, the intensity of the illumination light may be set to 0%. The gain for the dark output frame image data at this time may be the same as the gain for the just previous bright output frame image data or may be a gain of 0% or more and less than 80% applicable to the black insertion gain.

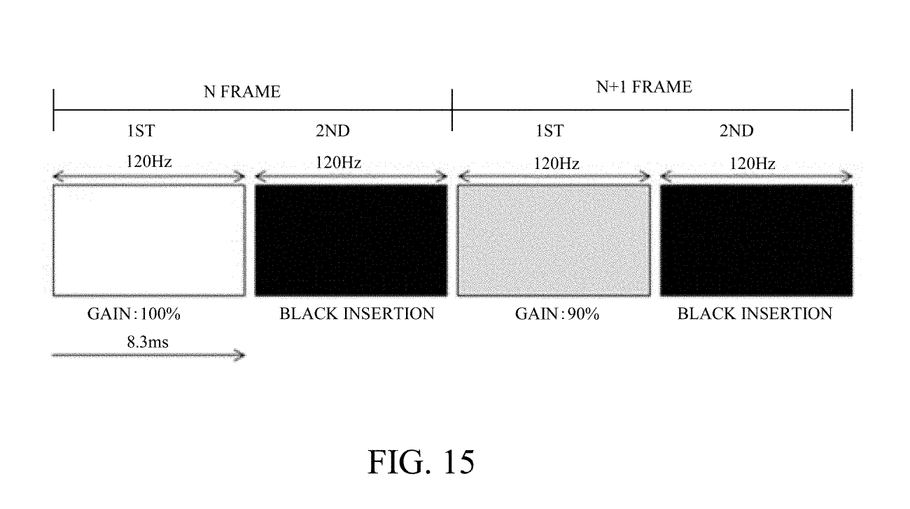

However, the flicker (bright and dark flicker) at a frame cycle is likely to stand out in the projection image by combining the bright and dark driving and the black insertion with each other. FIG. 15 illustrates a bright display image, a black insertion image, a dark display image, and a black insertion image which are switched by the double-speed drive illustrated in FIG. 12A. Since the bright display image is displayed at 30 Hz and the black insertion image and the dark display image are displayed among them, the flickers at 30 Hz are likely to be visually confirmed.

The light source controller (control unit) 330 changes the emission intensity (brightness) of the light source section 320 for each frame so that the intensity (light quantity) of the illumination light entering the liquid crystal element 3 varies for each frame. More specifically, the emission intensity of the light source section 320 in the N^{th} frame in which the liquid crystal element 3 is driven by the bright output frame image data and the black insertion frame image data is made lower than that in the (N+1)^{th} frame in which the liquid crystal element 3 is drive by the dark output frame image data and the black insertion frame image data. Thereby, the brightness of the bright display image is made closer to that of the dark display image so as to making the flickers less conspicuous. In the quadruple speed driving illustrated in FIG. 12B, the emission intensity of the light source section 320 for the half frame in each frame, in which the liquid crystal element 3 is driven by the bright output and black insertion frame image data, is made lower than that for the half frame in which the liquid crystal element 3 is driven by the dark output and black insertion frame image data. In order to change the emission intensity of the light source section 320, this embodiment, for example, darkens the light source at the initial first gain of 100% and the second gain of 0% in FIG. 12B, and brightens the light source at the third gain of 90% and the fourth gain of 0%.

When the liquid crystal element 3 is driven by the line-sequential driving method, it is necessary to control the emission intensity of the light source section 320 as described below. Referring to FIGS. 16A and 16B, a description will be given of the brightness control of the light source section 320 for each display pixel row (referred to as a “display area” hereinafter) of the liquid crystal element 3 when the liquid crystal element 3 is driven by the line-sequential driving method. The line-sequential driving method displays sequentially images from the upper display area in the liquid crystal element 3. FIG. 16A illustrates the upper first display area, the middle second display area, and the lower third display area as representative display areas. Images are displayed in order of the first display area, the second display area, and the third display area.

The bright display image and the black insertion image in the N^{th} frame and the dark display image and the black insertion image in the (N+1)^{th} frame are displayed at 120 Hz, and each display requires 8.3 ms. FIG. 16B illustrates the display timing of each display area where the abscissa axis is set to time. Image portions (image lines) displayed in the first, second, and third display areas in each image are referred to as first, second, and third image areas, respectively. Where the first image area in the bright display image in the N^{th} frame is displayed in the first display area in the liquid crystal element 3, the second image area in the bright display image is displayed in the second display area as about half of 8.3 ms elapses from there. As about half of 8.3 ms additionally elapses, the third image area in the bright display image is displayed in the third display area. The first, second, and third areas in each of the black insertion image of the N^{th} frame and the dark display image and black insertion image in the (N+1)^{th} frame are similarly sequentially displayed in the first, second, and third display areas in the liquid crystal element 3. This also applies to the subsequent frames.

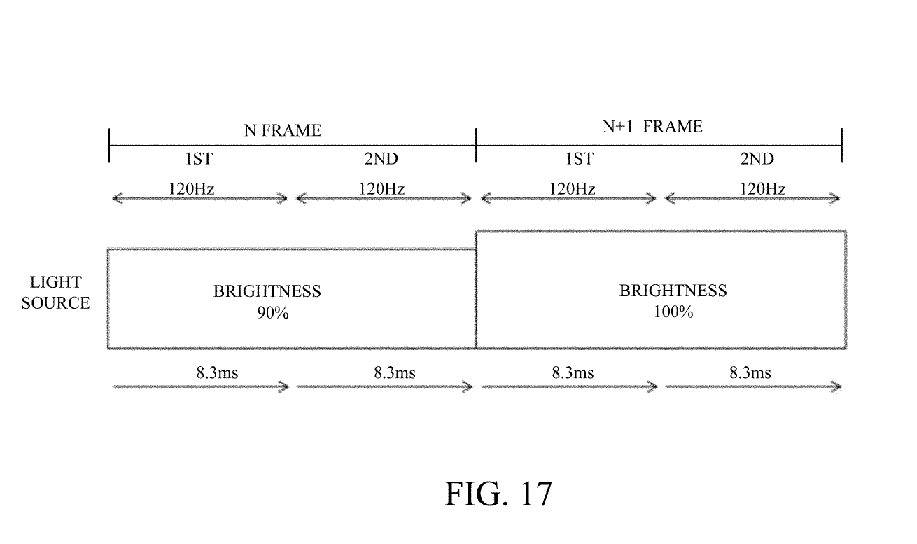

FIG. 17 illustrates a brightness change of the light source section 320 in this case. The light source controller 330 sets the brightness of the light source section 320 to 90% in the N^{th} frames and the brightness of the light source section 320 to 100% in the (N+1)^{th} frame. Similarly, in the subsequent frames, the brightness of the light source section 320 is repetitively changed.

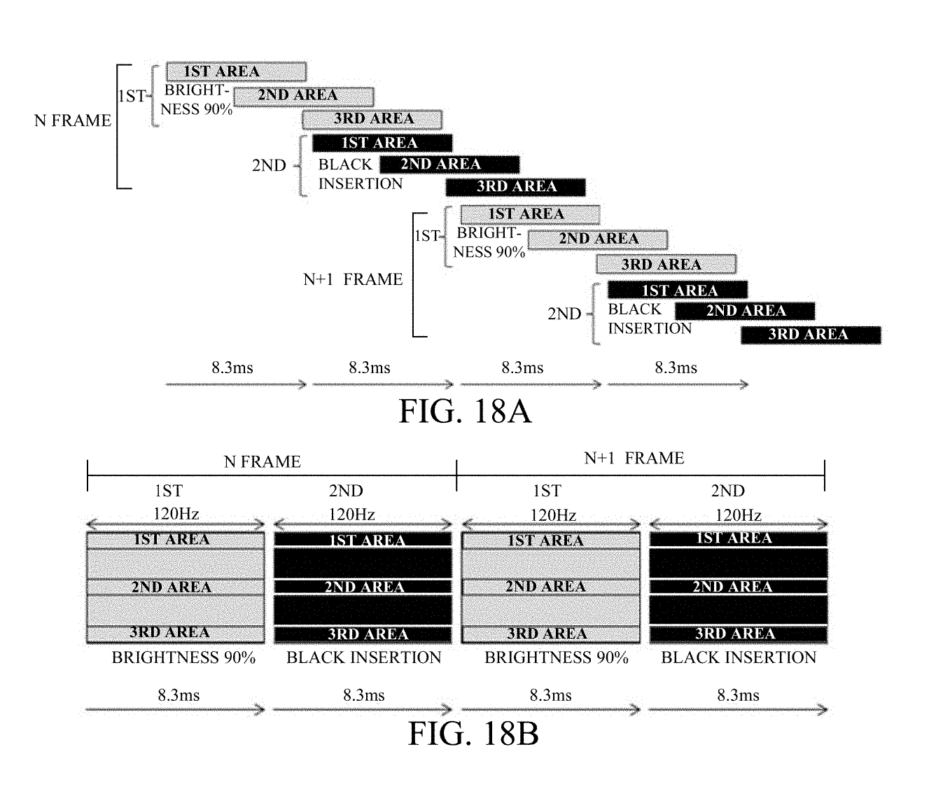

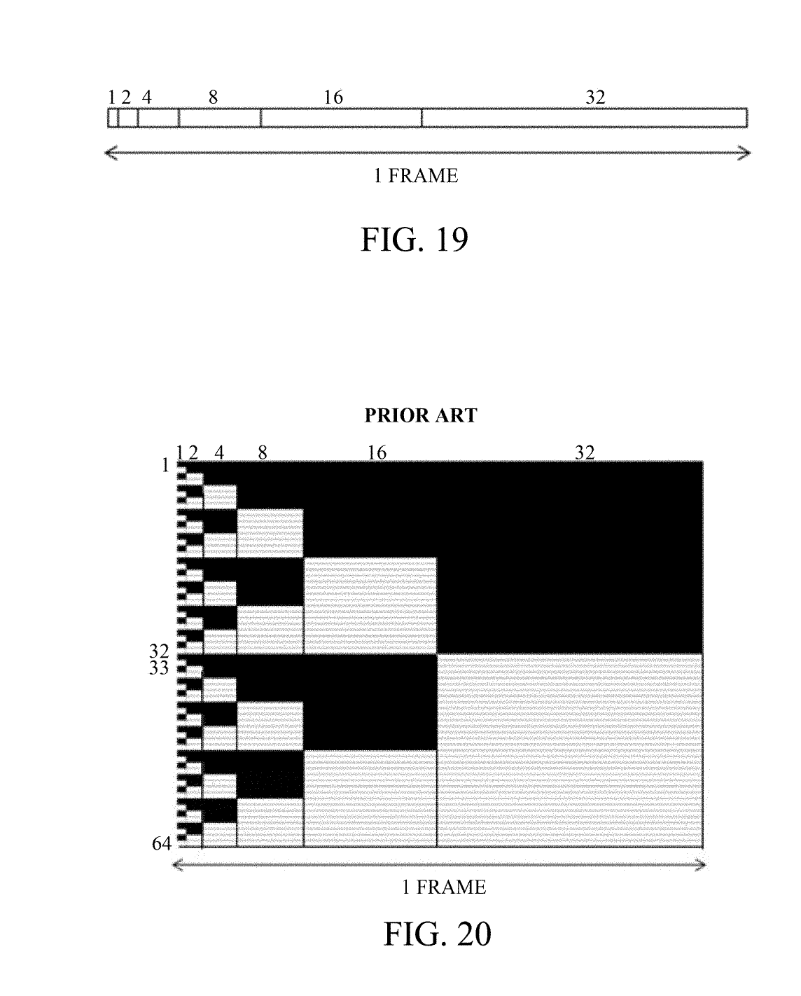

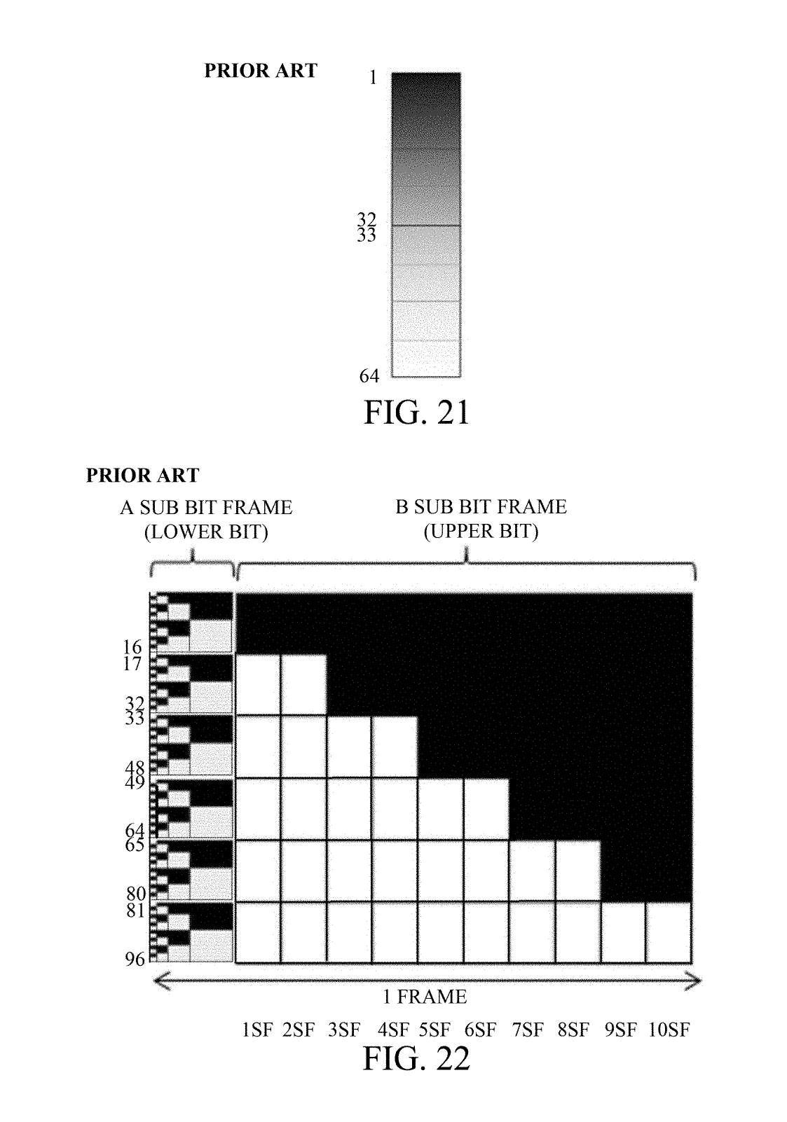

As illustrated in FIG. 18A, the brightness image is displayed in each frame, which corresponds to a product of the brightness of the light source section 320 and the brightness (gain) of each display area in the liquid crystal element 3.

It is necessary to maintain the brightness (gain) of 100% in the liquid crystal element 3 to the nearly end (16.6 ms) of the N^{th} frame in which the display time in the third display area ends in order to display the bright display image in the N^{th} frame. On the other hand, since the brightness of the light source section 320 is maintained 90% in the N^{th} frame, the brightness in the bright display image becomes 90% as illustrated in FIG. 18B. In order to display the dark display image of the (N+1)^{th} frame, it is necessary to maintain the brightness (gain) of 90% in the liquid crystal element 3 to the nearly end (16.6 ms) of the (N+1)^{th} frame in which the display time in the third display area ends. On the other hand, since the brightness of the light source section 320 is maintained at 100% in the (N+1)^{th} frame, the brightness of the dark display image is also maintained 90%.

In other words, the intensity of the illumination light is changed when the liquid crystal element 3 is driven based on the respective initial image lines of the bright output and the dark output frame image data. The intensity of the illumination light is maintained while the liquid crystal element 3 is driven based on the bright output or dark output frame image data and the subsequent black insertion frame image data. As a result, the brightness of the bright display image in the N^{th} frame approaches to (becomes equal to) the brightness of the dark display image in the (N+1)^{th} frame, and the flicker is less likely to be conspicuous.

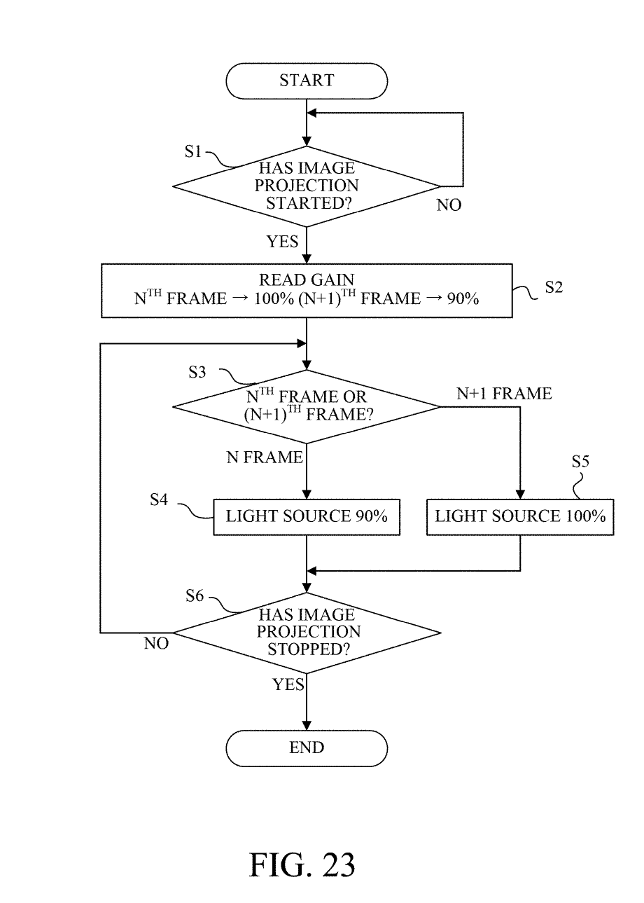

A flowchart in FIG. 23 illustrates the above light source control processing performed by the light source controller 330 as a computer in accordance with a computer program. As a result, the brightness of the light source section 320 is changed for each frame as illustrated in FIG. 17.

When an image projection start is instructed by a user operation or the like in the step S1, the light source control section 330 reads the gain (100%) in the N^{th} frame and the gain (90%) in the (N+1)^{th} frame set by the gain circuit 410 in the step S2.

Next, in the step S3, the light source controller 330 determines whether the frame to be displayed on the liquid crystal element 3 is the N^{th} frame or the (N+1)^{th} frame. If it is the N^{th} frame, the flow proceeds to the step S4, and if it is the (N+1)^{th} frame, the flow proceeds to the step S5.

In the step S4, the light source controller 330 drives the light source section 320 with the brightness of 90% in synchronization with the display in the N^{th} frame on the liquid crystal element 3. On the other hand, in the step S5, the light source controller 330 drives the light source section 320 with the brightness of 100% in synchronization with the display of the (N+1)^{th} frame on the liquid crystal element 3.

The light source control section 330 then determines whether or not an image projection stop is instructed in the step S6. If no instruction is given, the flow returns to step S3 to continue the brightness control of the light source section 320, and if the instruction is given, this flow ends.

As described above, this embodiment can present a good display image while making the flickers less conspicuous, where the bright and dark driving for suppressing the image degradation caused by the disclination and the black insertion for improving the motion image visibility are combined.

Each of the above embodiments can reduce the image degradation caused by the disclination while suppressing the brightness fluctuation in the black insertion for improving the visibility of a motion image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-234798, filed on Dec. 7, 2017, which is hereby incorporated by reference herein in its entirety.

What is claimed is:

1. A liquid crystal driving apparatus configured to drive a liquid crystal element which illumination light from a light source enters, the liquid crystal driving apparatus comprising:
an image data generator configured to generate display image data from each of input frame image data that is input consecutively;
a driver configured to enable each pixel to display a gradation by controlling, based on the display image data, an application of a first voltage to each pixel in the liquid crystal element in each of a plurality of subframe periods contained in one frame period and an application of a second voltage lower than the first voltage; and
a controller configured to control an intensity of the illumination light,
wherein the image data generator multiplies the input frame image data that is different from or equal to each other by a first gain and a second gain lower than the first gain, generates first display image data and second display image data, inserts black insertion image data between the first display image data and the second display image data and after the second display image data, and sequentially outputs the first display image data, the black insertion image data, the second display image data, and the black insertion image data as the display image data to the driver, the black insertion image data being generated by multiplying the input frame image data by a third gain lower than the second gain, and
wherein the controller makes lower the intensity of the illumination light when the liquid crystal element is driven based on the first display image data than that when the liquid crystal element is driven based on the second display image data.

2. The liquid crystal driving apparatus according to claim 1, wherein the controller lowers the intensity of the illumination light by lowering an emission intensity of the light source.

3. The liquid crystal driving apparatus according to claim 1, further comprising a light control element configured to change the intensity of the illumination light and provided between the light source and the liquid crystal element, and
wherein the controller lowers the intensity of the illumination light by controlling the light control element.

4. The liquid crystal driving apparatus according to claim 1, wherein the image data generator changes at least one of the first gain and the second gain whenever the image data generator generates the first display image data and the second display image data.

5. The liquid crystal driving apparatus according to claim 4, wherein the image data generator changes the first gain and the second gain so that a sum before the first gain and the second gain are changed is equal to a sum after the first gain and the second gain are changed.

6. The liquid crystal driving apparatus according to claim 1, wherein a difference between the first gain and the second gain is 2% or more to 20% or less of the first gain.

7. The liquid crystal driving apparatus according to claim 1, wherein the third gain is 0% or more and 80% or less.

8. The liquid crystal driving apparatus according to claim 1, wherein the controller makes lower the intensity of the illumination light when the liquid crystal element is driven based on the black insertion image data than that when the liquid crystal element is driven based on the first display image data.

9. The liquid crystal driving apparatus according to claim 8, wherein the controller sets the intensity of the illumination light to 0% when the liquid crystal element is driven based on the black insertion image data.

10. The liquid crystal driving apparatus according to claim 1, wherein the driver drives the liquid crystal element by a line-sequential driving method, and
wherein the controller changes the intensity of the illumination light when the liquid crystal element is driven based on an initial image line of each of the first display image data and the second display image data.

11. The liquid crystal driving apparatus according to claim 10, wherein the control unit does not change the intensity of the illumination light while the liquid crystal element is driven based on the first or second display image data and subsequent black insertion image data.

12. The liquid crystal driving apparatus according to claim 1, wherein the light source is a solid light source.

13. An image display apparatus comprising a liquid crystal driving apparatus configured to drive a liquid crystal element which illumination light from a light source enters,
wherein liquid crystal driving apparatus includes:
an image data generator configured to generate display image data from each of input frame image data that is input consecutively;
a driver configured to enable each pixel to display a gradation by controlling, based on the display image data, an application of a first voltage to each pixel in the liquid crystal element in each of a plurality of subframe periods contained in one frame period and an application of a second voltage lower than the first voltage; and
a controller configured to control an intensity of the illumination light,
wherein the image data generator multiplies the input frame image data that is different from or equal to each other by a first gain and a second gain lower than the first gain, generates first display image data and second display image data, inserts black insertion image data between the first display image data and the second display image data and after the second display image data, and sequentially outputs the first display image data, the black insertion image data, the second display image data, and the black insertion image data as the display image data to the driver, the black insertion image data being generated by multiplying the input frame image data by a third gain lower than the second gain, and
wherein the controller makes lower the intensity of the illumination light when the liquid crystal element is driven based on the first display image data than that when the liquid crystal element is driven based on the second display image data.

14. A method for driving a liquid crystal element which illumination light from a light source enters, the method comprising:
an image data generating step configured to generate display image data from each of input frame image data that is input consecutively;
a driving step configured to enable each pixel to display a gradation by controlling, based on the display image data, an application of a first voltage to each pixel in the liquid crystal element in each of a plurality of subframe periods contained in one frame period and an application of a second voltage lower than the first voltage; and
a controlling step configured to control an intensity of the illumination light,
wherein the image data generating step multiplies the input frame image data that is different from or equal to each other by a first gain and a second gain lower than the first gain, generates first display image data and second display image data, inserts black insertion image data between the first display image data and the second display image data and after the second display image data, and sequentially outputs the first display image data, the black insertion image data, the second display image data, and the black insertion image data as the display image data to the driver, the black insertion image data being generated by multiplying the input frame image data by a third gain lower than the second gain, and
wherein the control step makes lower the intensity of the illumination light when the liquid crystal element is driven based on the first display image data than that when the liquid crystal element is driven based on the second display image data.
